(19) United States
(12) Patent Application Publication
(10) Pub. No.: US 2026/0367487 A1
(43) Pub. Date: Nov. 19, 2026

(54) ACCESSORY OF INTERCHANGEABLE LENS MOUNT

(71) Applicant: CHENGDU WEIZHENG DIGITAL TECHNOLOGY CO., LTD., Chengdu (CN)

(72) Inventors: Yunhong Li, Chengdu (CN); Ronghua Yao, Chengdu (CN)

(21) Appl. No.: 19/738,390

(22) Filed: Jul. 11, 2026

(30) Foreign Application Priority Data
Apr. 3, 2026 (CN) 202610442802.0

(51) Int. Cl. G03B 17/56; G03B 17/14

(52) U.S. Cl. CPC G03B 17/56; G03B 17/14

(57) ABSTRACT

An accessory of an interchangeable lens mount includes a lens and a camera device. The lens includes a male snap ring, a lens signal terminal group, a positioning pin, and a limiting post. The camera device includes a female snap ring, a camera device signal terminal group, a positioning pin snap-in hole, a slider, a release button, and an elastic anti-backlash structure. At least one floating claw and several fixed claws are provided on the male snap ring, the number of claws on the female snap ring is equal to a sum of the number of the fixed claws and the floating claw, and the fixed claws and the floating claw on the male snap ring and the claws of the female snap ring are snap-fitted to each other to achieve axial limit.

### TECHNICAL FIELD

The present invention belongs to the technical field of camera device accessories, and relates to an accessory of an interchangeable lens mount.

### BACKGROUND

Interchangeable lens camera devices are widely used in professional photography, film and television shooting, industrial inspection and other fields by virtue of the advantage of flexible lens replacement. A mount connection structure between a lens and a camera device is a core component to ensure stable connection and reliable signal transmission therebetween, and performance thereof directly affects imaging quality and usage experience of the camera device.

In the prior art, the connection structures of interchangeable lens mounts often use fixed claws to achieve axial limit. This structure has the following defects: first, a radial clearance is easy to occur between the fixed claws and the mount, causing the lens to shake after mounting, which not only affects imaging stability, but also aggravates wear of the claws and terminal; second, the claws are all fixed, which cannot adaptively compensate for the fit clearance, resulting in insufficient mounting stability, and making connections prone to loosening under conditions such as vibration or movement; third, mating accuracy of signal terminals depends on processing and assembly accuracy of the claws, and any clearance or shaking can easily lead to signal transmission interruption or instability; and fourth, the disassembly operation of some mounts is complicated, requiring the use of both hands, and forceful removal can easily damage the signal terminals.

At present, although attempts have been made in the prior art to alleviate the clearance problem by adding elastic members, most of them are single elastic compensation structures and do not combine with the movable design of the claws. Consequently, they cannot fundamentally eliminate the radial clearance and axial shaking, and do not form an integrated linkage of mechanical positioning, signal connection and backlash elimination reinforcement, resulting in limited technical effect.

Therefore, in order to solve the above technical problems, the technical solution of the present application is provided.

### SUMMARY

An object of the present invention is to provide an accessory of an interchangeable lens mount to solve the technical problems of large connection clearance, insufficient mounting firmness, unstable signal transmission and inconvenient disassembly of interchangeable lens mounts in the prior art, which achieves integrated linkage of mechanical positioning, signal connection and backlash elimination reinforcement through collaborative design of a floating claw and an elastic backlash elimination structure, and improves connection stability and ease of use.

The technical solution adopted by the present invention is as follows:

An accessory of an interchangeable lens mount, includes a lens and a camera device; the lens includes a male snap ring, a lens signal terminal group, a positioning pin, and a limiting post; and the camera device includes a female snap ring, a camera device signal terminal group, a positioning pin snap-in hole, a slider, a release button, and an elastic anti-backlash structure.

At least one floating claw and several fixed claws are provided on the male snap ring, several claws are provided on the female snap ring, and the number of claws of the female snap ring is equal to a sum of the number of the fixed claws and the number of the floating claw, which achieves axial limit of the camera device and the lens, ensures stable axial position after connection, and avoids axial endplay.

The floating claw is fixed to a side wall of the male snap ring and located between two fixed claws, the floating claw is telescopically movable in a direction perpendicular to an axis of the male snap ring, and a core function of the floating claw is to adaptively eliminate a radial clearance between the lens and the camera device and enhance axial mounting firmness; thereby preventing the lens from shaking after mounting.

The lens signal terminal group is mounted and attached to an inner wall of the male snap ring, after the lens is mounted and fixed, the lens signal terminal group and the camera device signal terminal group are communicated in one-to-one correspondence to achieve interactive transmission of control instructions and signal protocols between the lens and the camera device, ensuring continuity and reliability of signal transmission.

The working principle of the present invention is to achieve stable connection of the lens and the camera device, accurate signal transmission and convenient disassembly through synergistic action of the floating claw and the elastic anti-backlash structure, and is specifically divided into three stages:

1. Assembly stage: An assembly mark and an alignment mark are used for positioning, the male snap ring is pushed into the female snap ring, the lens is rotated to gradually snap the claws of the male snap ring and the female snap ring to achieve axial limit; and synchronously the signal terminals are mated one by one, and the positioning pin is snapped in the snap-in hole under the action of a reset elastic piece to achieve mechanical anti-rotation; and an elastic piece of the elastic anti-backlash structure is deformed to compensate for the fit clearance, forming an integrated linkage.

2. Working stage: Under the action of an elastic carrier, the floating claw always abuts against an inner wall of the female snap ring to eliminate a radial clearance; the elastic anti-backlash structure continuously provides elastic force to compensate for an axial clearance, allowing the lens to evenly distribute the gravity and avoid shaking; and the signal terminal groups maintain accurate mating to achieve stable signal interaction.

3. Disassembly stage: The release button is pressed to drive the slider to eject the positioning pin through a wedge-shaped (or cam) fitting structure to release the mechanical anti-rotation; and the lens is rotated to disengage the claw and the signal terminals, and removed after the marks are aligned, completing the disassembly.

Further, the floating claw is connected with the male snap ring via an elastic carrier, the elastic carrier is preferably a compression spring, one end of the compression spring is fixedly connected with the bottom of a mounting groove of the male snap ring, the other end is fixedly connected with the bottom of the floating claw, and the floating claw achieves telescopic movement in the direction perpendicular to the axis of the male snap ring by extension and retraction of the compression spring, which result in a simple structure, high reliability, and allow achievement of adaptive clearance compensation.

Further, a width angle of the floating claw is smaller than width angles of two adjacent fixed claws, thereby preventing interference between the floating claw and the fixed claws while ensuring a telescopic space of the floating claw; a connecting line between one end of the floating claw and an axis center of the male snap ring and a connecting line between an adjacent end of the adjacent fixed claw and the axis center of the male snap ring form θ3 and θ4, with θ3+θ4<160 degrees, θ3<160 degrees, and θ4<160 degrees. Such an angle limit optimizes layout of the claws and improve the connection stability.

Further, a connecting line between a midpoint of an edge of the positioning pin and the axis center of the male snap ring cuts θ3 or θ4 into θ1 and θ2, with θ1+θ2<90 degrees. This angle design is different from the prior art, effectively avoids the technical limitation of the prior art patents, further optimizes the layout of the claws, and enhances the clearance elimination effect of the floating claw.

Further, the width angle of the fixed claw is a fan-shaped angle formed by a connecting line between a vertex of one end of the fixed claw and the axis center of the male snap ring and a connecting line between a vertex of the other end of the fixed claw and the axis center of the male snap ring, and the width angle of the fixed claw ranges from 30 degrees to 60 degrees, which ensures that the fixed claw has sufficient snap-fit strength while avoiding occupying too much circumferential space.

Further, the elastic anti-backlash structure includes five elastic pieces, the five elastic pieces are arranged in one-to-one correspondence with the claws of the female snap ring, one end of the elastic piece is fixedly connected with the female snap ring, the other end extends toward the claws of the male snap ring, and after the male snap ring and the female snap ring are snap-fitted, the elastic pieces abut against the corresponding claws and undergo elastic deformation. By adaptively compensating for the axial fit clearance between the camera device and the lens through elastic force, the gravity of the lens is evenly distributed in a circumferential direction, which completely eliminates the shaking of the connection part, ensures continuous and accurate mating of the signal terminal groups, and avoids component wear caused by shaking during use.

Further, a wedge-shaped fitting structure is provided between the release button and the slider, the release button can perform linear movement in a direction parallel to the axis of the male snap ring, the linear movement is converted into a vertical displacement of the slider by the wedge-shaped fitting structure, and the slider is used to eject the positioning pin and separate the positioning pin from the positioning pin snap-in hole, which achieves quick unlocking, convenient operation and avoids terminal damage caused by forceful removal.

Further, an elastic reset member is provided between the positioning pin and the male snap ring, and the elastic reset member is a reset elastic piece, and the reset elastic piece is sleeved on an outside of the positioning pin and is used to drive the positioning pin into the positioning pin snap-in hole, ensuring reliable snap fit of the positioning pin, and achieving mechanical anti-rotation of the male snap ring and the female snap ring.

Further, the lens signal terminal group and the camera device signal terminal group are both elastic terminals, contact end faces thereof are provided with wear-resistant coatings, and the wear-resistant coating is a gold plating layer, which improve the wear resistance and conductivity of the terminals, prolongs the service life, and ensure the stability of signal transmission.

Further, an outer side wall of the male snap ring is provided with an assembly mark, and an outer side wall of the female snap ring is correspondingly provided with an alignment mark; when the lens is assembled, the assembly mark is aligned with the alignment mark; and when the lens is disassembled, the lens is rotated until the assembly mark and the alignment mark are aligned again, and then the lens is pulled out along the axis, facilitating quick and easy assembly and disassembly for a user and enhancing ease of use.

In summary, by adopting the above technical solution, the present invention has the following beneficial effects:

1. The accessory of an interchangeable lens mount replaces the fixed claws found in the prior art with floating claws. The floating claw can be extended and retracted in the direction perpendicular to the axis, and can adaptively eliminate the radial clearance between the lens and the camera device, and can enhance the axial mounting firmness, solving the technical problem of shaking in existing mount connection.

2. In the present invention, an elastic anti-backlash structure is provided to cooperate with the floating claw to adaptively compensate for the axial fitting clearance through elastic deformation of the elastic piece, so that the gravity of the lens is evenly distributed in the circumferential direction, which completely eliminates the shaking of the connection part, ensures continuous and accurate mating of the signal terminal groups, avoids component wear caused by shaking during use, and improves connection stability and service life.

3. In the present invention, integrated linkage of mechanical positioning, signal connection and backlash elimination reinforcement is achieved: during rotational assembly, the claws are snap-fitted to achieve axial limit, the signal terminals are accurately mated one by one, and the positioning pin is snapped in the snap-in hole to achieve mechanical rotation, thereby simultaneously completing signal matching and ensuring the continuity and reliability of signal transmission.

4. In the present invention, the wedge-shaped fit between the release button and the slider allows the entire process of unlocking, rotating, and removing to be completed with a single hand, avoiding terminal damage caused by forceful removal and improving the use experience.

5. In the present invention, the lens signal terminal group and the camera device signal terminal group adopt elastic terminals and are provided with gold-plated wear-resistant coating to improve conductivity and wear resistance, which further ensures stable signal transmission and prolongs the service life of the accessory.

6. In the present invention, radial compensation constraint of the lens by the floating claw can well eliminate the radial clearance of the lens, and imaging of short-focus and wide-angle lenses can better match back focus stability.

### BRIEF DESCRIPTION OF THE DRAWINGS

In order to illustrate the technical solutions of the embodiments of the present invention more clearly, the following briefly introduces the accompanying drawings used in the embodiments, experimental examples, and comparative examples. It should be understood that the following drawings only illustrate some embodiments of the present invention, and should be regarded as a limitation of the scope, and for those of ordinary skill in the art, other related drawings can also be obtained according to these drawings without any creative effort, in which:

FIG. 1 is an exploded view of a male snap ring and a female snap ring in the present invention;

FIG. 2 is an exploded view of a male snap ring in the present invention;

FIG. 3 is a front view of connection between the male snap ring and the female snap ring in the present invention;

FIG. 4 is a structural cross-sectional view of connection between a floating claw and the male snap ring and the female snap ring in the present invention;

FIG. 5 is a partially enlarged structural schematic diagram of FIG. 4;

FIG. 6 is a schematic diagram of definitions of angles θ1, θ2, θ3, and θ4 in the present invention;

FIG. 7 is an exploded view of a camera device in the present invention; and

FIG. 8 is a structural cross-sectional view of connection between a release button and a slider in the present invention.

Description of reference numerals: 1—male snap ring, 2—lens signal terminal group, 3—positioning pin, 4—limiting post, 5—female snap ring, 6—camera device signal terminal group, 7—positioning pin snap-in hole, 8—slider, 9—release button, 10—elastic anti-backlash structure, 11—floating claw, 12—fixed claw, 13—claw, 14—compression spring, 15—elastic piece, 16—wedge-shaped fitting structure, and 17—reset elastic piece.

### DETAILED DESCRIPTION OF THE EMBODIMENTS

To make the purpose, technical solution and advantages of the present invention more clear, the present invention will be further described in detail below in conjunction with the accompanying drawings, embodiments, experimental examples, and comparative examples. It should be understood that the specific embodiments described here are only used to explain the present invention and are not intended to limit the present invention. That is, the described embodiments are only some, not all, of the embodiments of the present invention. It will be readily understood that the components of the embodiments of the disclosure, as generally described and illustrated in the drawings herein, may be arranged and designed in a wide variety of different configurations.

Thus, the following detailed description of the embodiments of the present invention is not intended to limit the scope of the present invention as claimed, but is merely representative of selected embodiments of the present invention. Based on the embodiments of the present invention, all other embodiments obtained by those skilled in the art without creative work shall fall within the protection scope of the present invention.

It should be noted that the terms “first” and “second” and other similar relational terms are only used to distinguish one entity or operation from another entity or operation, and do not necessarily require or imply any such actual relationship or order between these entities or operations. Moreover, the terms “includes”, “including”, or any other variations thereof are intended to encompass a non-exclusive inclusion such that a process, method, article, or device that includes a list of elements includes not only those elements, but also other elements not explicitly listed, or elements inherent to such process, method, article, or device. Without further limitations, an element defined by the phrase “including a . . . ” does not preclude the presence of additional identical elements in the process, method, article, or device including that element.

The features and performance of the present invention will be further described in detail below with reference to embodiments.

### I. EMBODIMENTS

### Embodiment 1

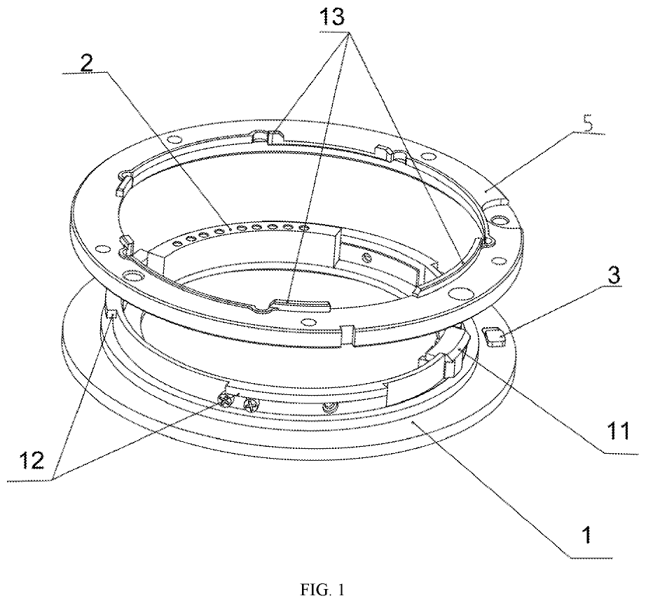

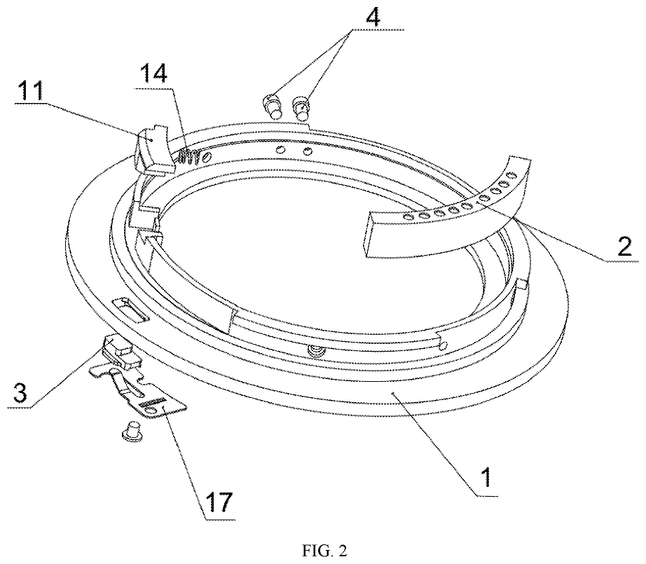

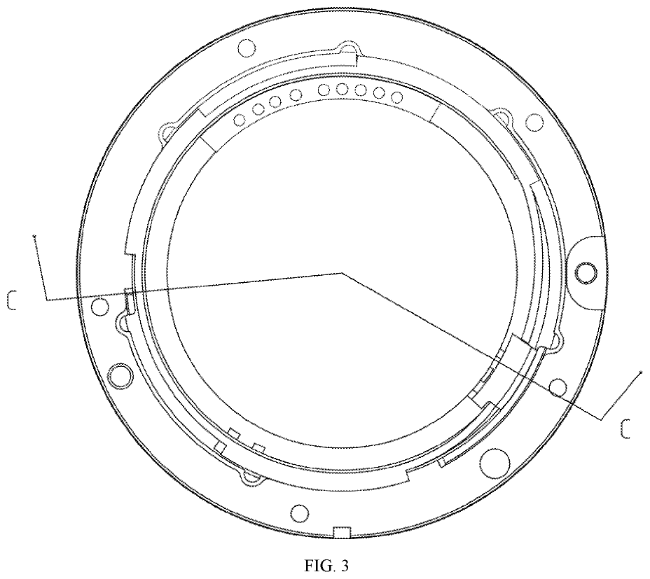

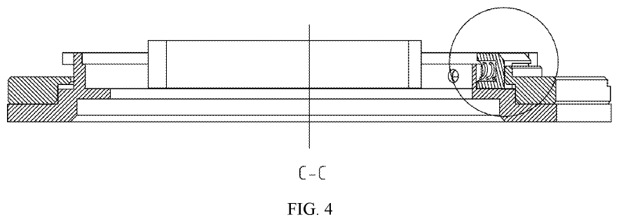

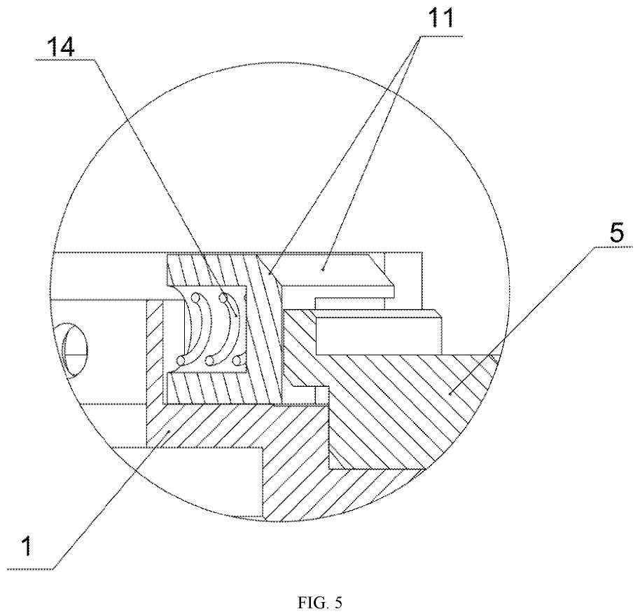

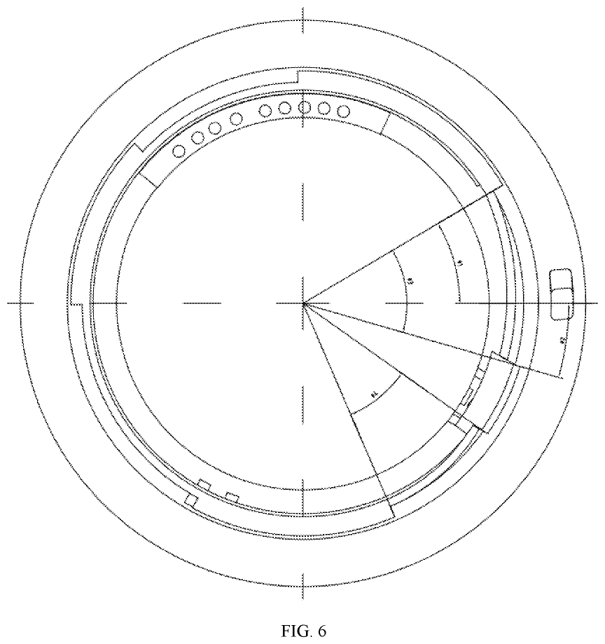

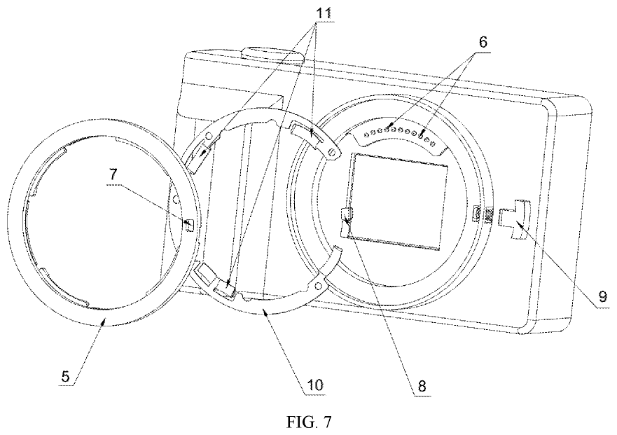

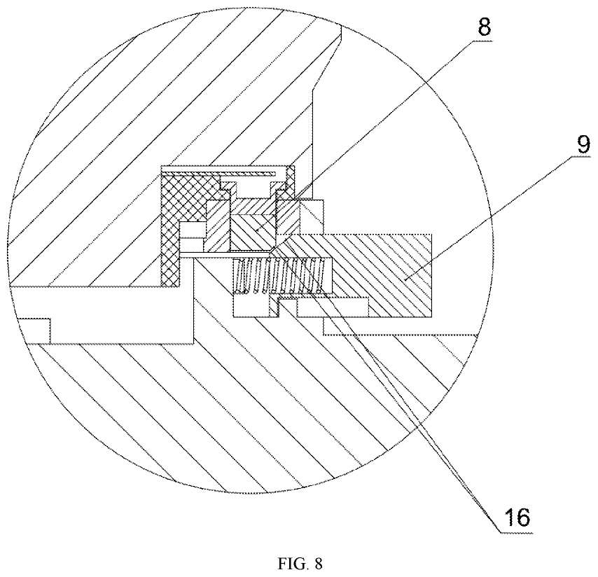

An accessory of an interchangeable lens mount of the present invention, as shown in FIGS. 1, 2, 3, 4, 5, 6, 7 and 8, includes a lens and a camera device; the lens includes a male snap ring 1, a lens signal terminal group 2, a positioning pin 3, and a limiting post 4, the camera device includes a female snap ring 5, a camera device signal terminal group 6, a positioning pin snap-in hole 7, a slider 8, a release button 9, and an elastic anti-backlash structure 10; and at least one floating claw 11 and several fixed claws 12 are provided on the male snap ring 1, several claws 13 are provided on the female snap ring 5, and the number of claws 13 of the female snap ring 5 is equal to a sum of the number of the fixed claws 12 and the number of the floating claw 11.

The floating claw 11 and the fixed claws 12 of the male snap ring 1 and the claws 13 of the female snap ring 5 are snap-fitted to each other to achieve axial limit of the camera device and the lens.

The floating claw 11 is fixed to a side wall of the male snap ring 1 and located between two fixed claws 12, the floating claw 11 is telescopically movable in a direction perpendicular to an axis of the male snap ring 1, and the floating claw 11 is capable of adaptively eliminating a radial clearance between the lens and the camera device and enhances axial mounting firmness.

The lens signal terminal group 2 is mounted and attached to an inner wall of the male snap ring 1, after the lens is mounted and fixed, the lens signal terminal group 2 and the camera device signal terminal group 6 are communicated in one-to-one correspondence to achieve interactive transmission of control instructions and signal protocols between the lens and the camera device.

The floating claw 11 is connected with the male snap ring 1 via an elastic carrier, the elastic carrier is a compression spring 14, one end of the compression spring 14 is fixedly connected with the bottom of a mounting groove of the male snap ring 1, the other end is fixedly connected with the bottom of the floating claw 11, and the floating claw 11 achieves telescopic movement in the direction perpendicular to the axis of the male snap ring 1 by extension and retraction of the compression spring 14.

A width angle of the floating claw 11 is smaller than width angles of two adjacent fixed claws 12; a connecting line between one end of the floating claw 11 and an axis center of the male snap ring 1 and a connecting line between an adjacent end of the adjacent fixed claw 12 and the axis center of the male snap ring 1 form θ3 and θ4, with θ3+θ4<160 degrees, θ3<160 degrees, and θ4<160 degrees.

A connecting line between a midpoint of an edge of the positioning pin 3 and the axis center of the male snap ring 1 cuts θ3 or θ4 into θ1 and θ2, with θ1+θ2<90 degrees.

The width angle of the fixed claw 12 is a fan-shaped angle formed by a connecting line between a vertex of one end of the fixed claw 12 and the axis center of the male snap ring 1 and a connecting line between a vertex of the other end of the fixed claw 12 and the axis center of the male snap ring 1, and the width angle of the fixed claw 12 ranges from 30 degrees to 60 degrees.

The elastic anti-backlash structure 10 includes five elastic pieces 15, the five elastic pieces 15 are arranged in one-to-one correspondence with the claws 13 of the female snap ring 5, one end of the elastic piece 15 is fixedly connected with the female snap ring 5, the other end extends toward the claws of the male snap ring 1, and after the male snap ring 1 and the female snap ring 5 are snap-fitted, the elastic pieces 15 abut against the corresponding claws 13 and undergo elastic deformation.

A wedge-shaped fitting structure 16 is provided between the release button 9 and the slider 8, the release button 9 can perform linear movement in a direction parallel to the axis of the male snap ring 1, the linear movement is converted into a vertical displacement of the slider 8 by the wedge-shaped fitting structure 16, and the slider 8 is used to eject the positioning pin 3 and separate the positioning pin from the positioning pin snap-in hole 7.

An elastic reset member is provided between the positioning pin 3 and the male snap ring 1, the elastic reset member is a reset elastic piece 17, and the reset elastic piece 17 is sleeved on an outside of the positioning pin 3 and is used to drive the positioning pin 3 into the positioning pin snap-in hole 7.

The lens signal terminal group 2 and the camera device signal terminal group 6 are both elastic terminals, contact end faces thereof are provided with wear-resistant coatings, and the wear-resistant coating is a gold plating layer.

An outer side wall of the male snap ring 1 is provided with an assembly mark, and an outer side wall of the female snap ring 5 is correspondingly provided with an alignment mark; when the lens is assembled, the assembly mark is aligned with the alignment mark; and when the lens is disassembled, the lens is rotated until the assembly mark and the alignment mark are aligned again, and then the lens is pulled out along the axis.

The specific implementation of the present embodiment is as follows: the accessory includes a lens and a camera device, the lens includes a male snap ring, a lens signal terminal group, a positioning pin, a limiting post, one floating claw and two fixed claws, and the camera device includes a female snap ring, a camera device signal terminal group, a positioning pin snap-in hole, a slider, a release button and an elastic anti-backlash structure.

Three claws are provided on the female snap ring, the number of claws of the female snap ring is equal to a sum of the number of the fixed claws (2) and the number of the floating claw (1), and the claws of the male snap ring (2 fixed claws+1 floating claws) are snap-fitted to the three claws of the female snap ring in one-to-one correspondence, which achieves axial limit of the camera device and the lens and prevent axial endplay thereof.

The floating claw is fixed to a side wall of the male snap ring and located between two fixed claws, the floating claw is connected with the male snap ring via a compression spring (elastic carrier), one end of the compression spring is welded and fixed to the bottom of a mounting groove of the male snap ring, and the other end is welded and fixed to the bottom of the floating claw; and the floating claw achieves telescopic movement in the direction perpendicular to the axis of the male snap ring by extension and retraction of the compression spring, and the telescopic stroke is 0.5-1 mm, which is used to eliminate the radial clearance between the lens and the camera device and enhance the axial mounting firmness.

The lens signal terminal group is mounted and attached to an inner side wall of the male snap ring and subject to flush mounting. The lens signal terminal group includes 8 elastic terminals evenly distributed in a ring shape; the camera device signal terminal group is correspondingly provided with 8 elastic terminals which are mounted and attached to an inner side wall of the female snap ring. After the lens is mounted and fixed, the lens signal terminal group and the camera device signal terminal group are communicated in one-to-one correspondence to achieve interactive transmission of control instructions and signal protocols between the lens and the camera device. Contact end faces of the lens signal terminal group and the camera device signal terminal group are provided with gold-plated wear-resistant coating, and coating is 0.1 mm thick, improving conductivity and wear resistance.

The width angle of the floating claw is 25 degrees, the width angle of the adjacent two fixed claws is 45 degrees, the width angle of the floating claw is smaller than the width angle of the adjacent fixed claws to avoid interference therebetween. A connecting line between one end of the floating claw and an axis center of the male snap ring and a connecting line between an adjacent end of the adjacent fixed claw and the axis center of the male snap ring form θ3 and θ4, with θ3=75 degrees, θ4=70 degrees, θ3+θ4=145 degrees<160 degrees, θ3<160 degrees, and θ4<160 degrees. A connecting line between a midpoint of an edge of the positioning pin and the axis center of the male snap ring cuts θ3 into θ1 and θ2, with θ1=40 degrees, θ2=35 degrees, and θ1+θ2=75 degrees<90 degrees.

The width angle of the fixed claw is a fan-shaped angle formed by a connecting line between a vertex of one end of the fixed claw and the axis center of the male snap ring and a connecting line between a vertex of the other end of the fixed claw and the axis center of the male snap ring. In the present invention, the width angle of the fixed claw is 45 degrees, which ensures that the fixed claw has sufficient snap-fit strength.

The elastic anti-backlash structure includes five elastic pieces which are arranged in one-to-one correspondence with the three claws of the female snap ring (2 claws correspond to 2 elastic pieces, and 1 claw corresponds to 1 elastic piece, ensuring full coverage). The elastic piece is made of spring steel and has a thickness of 0.3 mm. One end of the elastic piece is fixedly connected with the female snap ring by screws, and the other end extends toward the claws of the male snap ring. After the male snap ring and the female snap ring are snap-fitted, the elastic pieces abut against the corresponding claws and undergo elastic deformation, the deformation stroke is 0.3-0.5 mm, and the axial fit clearance is adaptively compensated by the elastic force.

A wedge-shaped fitting structure is provided between the release button and the slider, the release button can perform linear movement in the direction parallel to the axis of the male snap ring with a stroke of 5 mm, the wedge-shaped surface of the release button fits the wedge-shaped surface of the slider. When the release button is pressed, the linear movement is converted into a vertical displacement of the slider by the wedge-shaped fitting structure, and the vertical displacement of the slider is 2 mm, and is used to eject the positioning pin and separate the positioning pin from the positioning pin snap-in hole.

A rest elastic piece (elastic reset member) is provided between the positioning pin and the male snap ring, and the rest elastic piece is sleeved on an outside of the positioning pin, and an elastic coefficient of the reset elastic piece is 5 N/mm which is used to drive the positioning pin into the positioning pin snap-in hole, ensuring reliable snap fit of the positioning pin, and achieving mechanical anti-rotation of the male snap ring and the female snap ring.

An outer side wall of the male snap ring is provided with a triangular assembly mark, and an outer side wall of the female snap ring is correspondingly provided with a triangular alignment mark. When the lens is assembled, the assembly mark is aligned with the alignment mark, at this time, the claws of the male snap ring are aligned with a notch of the female snap ring, which is convenient for insertion. When the lens is disassembled, the lens is rotated until the assembly mark and the alignment mark are aligned again, and then the lens is pulled out along the axis.

The working principles of the present embodiment are as follows:

During assembly, the male snap ring of the lens is aligned with the female snap ring of the camera device, so that the assembly mark of the male snap ring is aligned with the alignment mark of the female snap ring, at this time, the claws of the male snap ring are aligned with the notch of the female snap ring, the lens is pushed in along the axis so that the end faces of the male snap ring and the female snap ring fit; the lens is held in hand and rotated clockwise, and the claws of the male snap ring and the claws of the female snap ring are gradually snap-fitted to each other to achieve preliminary axial limit of the camera device and the lens. Meanwhile, the lens signal terminal group and the camera device signal terminal group are accurately mated one by one to ensure the continuity of signal transmission. When the positioning pin is rotated to the positioning pin snap-in hole, the positioning pin is snapped in the positioning pin snap-in hole under the elastic force of the reset elastic piece to achieve mechanical anti-rotation of the male snap ring and the female snap ring. At this time, the signal terminal groups complete the final accurate matching, the elastic pieces of the elastic anti-backlash structure abut against the claws and undergo elastic deformation to adaptively compensate for the fit clearance, forming an integrated linkage of mechanical positioning, signal connection and backlash elimination reinforcement, and completing the assembly.

During disassembly, the release button is pressed to overcome the elastic force of the reset elastic piece to allow the release button to move linearly, the wedge-shaped surface of the release button converts the linear movement into the vertical displacement of the slider, and the slider ejects the positioning pin to separate the positioning pin from the positioning pin card hole, releasing the mechanical anti-rotation constraints of the male snap ring and the female snap ring. The lens is held in hand and rotated counterclockwise, the claws of the male snap ring and the female snap ring are gradually disengaged, and the signal terminal groups are disengaged one by one to avoid terminal damage caused by forceful removal. When the lens is rotated until the assembly mark and the alignment mark are aligned again, the lens is pulled out along the axis to complete the disassembly, and the entire process can be performed with one hand.

### Embodiment 2

The present invention provides an accessory of an interchangeable lens mount, as shown in FIGS. 1, 2, 3, 4, 5, 6, 7, and 8. The specific implementation of the present embodiment is as follows: the present embodiment differs from Embodiment 1 in that the number of floating claws is 2, the number of fixed claws is 3, and the number of claws on the female snap ring is 5 (3 fixed claws+2 floating claws), and the other structures are the same as those in Embodiment 1.

Specifically, the two floating claws are respectively located in two clearances between the three fixed claws. Each floating claw is connected with the male snap ring by a compression spring and has a telescopic stroke of 0.6-1.2 mm. Each floating claw has a width angle of 28 degrees, and each adjacent fixed claw has a width angle of 40 degrees. A connecting line between one end of each floating claw and the axis center of the male snap ring and a connecting line between an adjacent end of the adjacent fixed claw and the axis center of the male snap ring form θ3 and θ4. Among them, θ3=72 degrees and θ4=68 degrees for one of the floating claws, θ3=70 degrees and θ4=71 degrees for the other floating claw, both meeting θ3+θ4<160 degrees, θ3<160 degrees, and θ4<160 degrees. The connecting line between the midpoint of the edge of the positioning pin and the axis center of the male snap ring cuts θ3 corresponding to each floating claw into θ1 and θ2, θ1=38 degrees and θ2=34 degrees for one of the floating claws, and θ1=39 degrees and θ2=31 degrees for the other floating claw, both meeting θ1+θ2<90 degrees.

The five elastic pieces of the elastic anti-backlash structure are arranged in one-to-one correspondence with the five claws of the female snap ring. Each elastic piece abuts against the corresponding claw, further improving the clearance compensation effect, making the lens more firmly mounted, and eliminating shaking more thoroughly.

### Embodiment 3

The present invention provides an accessory of an interchangeable lens mount, as shown in FIGS. 1, 2, 3, 4, 5, 6, 7, and 8. The specific implementation of the present embodiment is as follows: the present embodiment differs from Embodiment 1 in that the elastic carrier is an elastic rubber block, the width angle of the fixed claw is 30 degrees, and the width angle of the floating claw is 20 degrees, and the other structures are the same as those in Embodiment 1.

The elastic rubber block has a Shore hardness of 70D, one end is bonded and fixed to the bottom of the mounting groove of the male snap ring, and the other end is bonded and fixed to the bottom of the floating claw. Through elastic deformation of the elastic rubber block, the floating claw achieves telescopic movement in a direction perpendicular to the axis of the male snap ring, and the telescopic stroke is 0.4-0.9 mm. The elastic rubber block has good buffering performance, which can further reduce vibration transmission and achieve clearance compensation.

For the floating claw, θ3=78 degrees, θ4=65 degrees, θ3+θ4=143 degrees<160 degrees. The connecting line between the midpoint of the edge of the positioning pin and the axis center of the male snap ring cuts θ4 into θ1 and θ2, with θ1=36 degrees, θ2=29 degrees, and θ1+θ2=65 degrees<90 degrees, which meets the requirement of angle limitation, optimizes the layout of the claws, and improves the connection stability.

### Embodiment 4

The present invention provides an accessory of an interchangeable lens mount, as shown in FIGS. 1, 2, 3, 4, 5, 6, 7, and 8. The specific implementation of the present embodiment is as follows: the present embodiment differs from Embodiment 1 in that both the lens signal terminal group and the camera device signal terminal group have 10 terminals, the number of the elastic pieces of the elastic anti-backlash structure is 6, and the other structures are the same as those in Embodiment 1.

The ten elastic terminals are evenly distributed in a ring shape, with a spacing of 36 degrees, which can realize the transmission of more signals, and are suitable for high-definition photography, high-speed continuous shooting and other scenes. The six elastic pieces are arranged in one-to-one correspondence with the three claws of the female snap ring (each claw corresponds to 2 elastic pieces), the thickness of the elastic piece is 0.4 mm, and the deformation stroke is 0.4-0.6 mm, which further improves the axial clearance compensation ability, and ensures stable connection of the lens under complex working conditions (such as severe vibration), and uninterrupted signal transmission.

### Embodiment 5

The present invention provides an accessory of an interchangeable lens mount, as shown in FIGS. 1, 2, 3, 4, 5, 6, 7, and 8. The specific implementation of the present embodiment is as follows: the present embodiment differs from Embodiment 1 in that the wedge-shaped fitting structure of the release button is replaced with a cam fitting structure, and the other structures are the same as those in Embodiment 1.

The cam is fixed to a lower end of the release button, and an upper end of the slider is provided with a groove matching with the cam. When the release button is pressed, the release button drives the cam to rotate, and the cam pushes the slider to perform vertical displacement through a groove to achieve ejection and unlocking of the positioning pin. The cam fitting structure has high transmission efficiency, resulting in smoother unlocking and less wear, and extending the service life of the release mechanism.

### II. EXPERIMENTAL EXAMPLES

In order to verify the technical effect of the accessory of the interchangeable lens mount provided in the present invention, the following experimental examples were designed for key properties thereof (connection stability, signal transmission reliability, ease of operation and durability). The experimental examples were tested based on the structure and parameters of the previous embodiments, and all the data were derived from the measurement results obtained in the laboratory under simulated actual usage scenarios.

### Experimental Example 1

### Connection Stability Test (Radial and Axial Clearance Elimination Effect)

Test object: Accessory of Embodiment 1 (1 floating claw, and 2 fixed claws).

Comparison object: Comparative Example 1 (see Comparative Examples below for details).

### Test Methods:

The lens and the camera device were assembled and locked according to standard procedures.

A laser displacement sensor was used to measure micro displacement (shaking) of the lens with respect to the camera device in the radial (X, Y directions) and axial (Z direction) directions.

Periodic micro amplitude vibration (frequency 2 Hz, amplitude+0.5 mm) simulating handheld jitter was applied to the assembly for 5 minutes, and the maximum shaking displacement was recorded.

Immediately after vibration, a simulated running vibration test (frequency 10 Hz, amplitude+2 mm) was performed for 2 minutes, and the maximum shaking displacement was recorded.

TABLE 1
(Test Results of Experimental Example 1)

| | The present | Comparative |
|---|---|---|
| | invention | Example 1 |
| Test Item | (Embodiment 1) | (all fixed claws) |
| Shaking after static assembly | ≤0.02 mm | 0.05-0.10 mm |
| Maximum shaking under handheld | ≤0.05 mm | 0.15-0.25 mm |
| jitter | | |
| Maximum shaking under running | ≤0.08 mm | 0.30-0.50 mm |
| vibration | | |

Conclusion: The floating claw of the present invention cooperates with the elastic anti-backlash structure to effectively eliminate radial and axial clearance. Under various working conditions, the amount of connection shaking was significantly lower than that of the traditional fixed claw structure, improving imaging stability and mechanical reliability.

### Experimental Example 2

### Signal Transmission Stability Test

Test object: Accessory of Embodiment 1 (8 elastic signal terminals).

Comparison object: Comparative Example 1.

### Test Methods:

A high-speed data communication link was established between the lens and the device (analog 4K 60 fps video data stream).

After assembly, the signal transmission bit error rate (BER) was monitored statically for 1 hour.

While performing the “running vibration test” of Experimental Example 1, the number of instantaneous interruptions of signal transmission (loss of signal lasting >1 ms is counted as an interruption) and the average BER were monitored.

TABLE 2
(Test Results of Experimental Example 2)

| | The present | Comparative |
|---|---|---|
| | invention | Example 1 |
| Test condition | (Embodiment 1) | (all fixed claws) |
| Static bit error rate (BER) | <10⁻¹² | <10⁻¹² |
| Number of interruptions under | 0 | 3-8 times |
| vibration | | |
| Average BER under vibration | <10⁻¹¹ | 10⁻⁹~10⁻⁷ |

Conclusion: The stable mechanical connection of the present invention ensured accurate mating of the signal terminal groups, and could still maintain “zero-interruption” and high-reliability signal transmission under severe vibration. However, in the Comparative Example, the terminal contact was unstable due to connection shaking, and the signal interruptions and bit error rate increased significantly.

### Experimental Example 3

### Ease of Disassembly Operation and Safety Test

Test object: Accessory of Embodiment 1 (with release button).

Comparison object: Comparative Example 3 (see Comparative Examples below for details).

### Test Methods:

Ten testers with different palm sizes used the accessories of the present invention and the accessories of the comparative examples to perform 10 consecutive assembly and disassembly operations.

The time required for a single complete disassembly operation (from the decision to disassemble until the lens is completely separated) was recorded.

The record included whether “misoperation” (e.g. wrong direction of rotation, excessive force, etc.) occurred during disassembly and whether visual scratches or deformations of the signal terminals were observed.

The maximum pressing force required for the unlocking mechanism (release button) during removal was measured.

TABLE 3
(Test Results of Experimental Example 3)

| | The present | Comparative | |
|---|---|---|---|
| | invention | Example 3 | |
| Test Item | (Embodiment 1) | (traditional buckle) | |
| Average single disassembly | 1.5 ± 0.3 | 3.2 ± 0.8 | seconds |
| time | seconds | | |
| Number of misoperation | 0 | 7 times | |
| occurrences (total 100 | | | |
| times) | | | |
| Terminal damage cases | 0 | 3 cases (minor | |
| | | scratches) | |
| Unlocking pressing force | 8 ± 1 N | 15 ± 3 | N |

Conclusion: The release button design of the present invention made the disassembly operation faster, intuitive and labor-saving, required virtually no learning cost, effectively avoided physical damages of the terminals caused by forceful removal or misoperations, and significantly improved user experience.

### Experimental Example 4

### Durability Test (Long-Term Insertion/Removal and Vibration)

Test object: Accessory of Embodiment 1.

### Test Methods:

Insertion/Removal Life Test: Continuous insertion and removal operations were performed on a special life testing machine according to standard procedures, and claw wear, plastic deformation of elastic pieces, terminal coating wear and signal connectivity were checked every 5,000 times.

Vibration durability test: The assembled accessory was fixed on a vibration table and a broadband random vibration test (frequency 5-500 Hz, RMS acceleration 2.5 Grms) was performed for 24 hours. After the test, the structural integrity, the amount of connection shaking (Experimental Example 1 was retested) and signal stability (Experimental Example 2 was tested) were inspected.

TABLE 4
(Test Results of Experimental Example 4)

| Test phase | Results |
|---|---|
| After 10,000 | No visible deep wear was found on the contact surfaces of the claws |
| insertion/removal | and the claws of the female snap ring; the resilience of the elastic |
| cycles | piece decreased by less than 8%; the contact resistance of the |
| | terminals changed by less than 5%; and the signal connectivity was |
| | normal. |
| After 20,000 | The floating claw was extended and retracted smoothly; the elastic |
| insertion/removal | piece had slight permanent deformation, but functioned normally; |
| cycles | and the gold plating layer of the terminals showed local wear on the |
| | base, but the signal transmission index (BER) was still within the |
| | allowable range (<10⁻¹⁰). |
| After vibration | All structural members were free from loosening and cracking; the |
| durability test | amount of connection shaking increased by less than 0.01 mm |
| | compared with that before vibration; and there was no interruption |
| | in signal transmission and no degradation in BER. |

Conclusion: After simulated long-term use of the accessory of the present invention, key mechanical components and electrical connectors both showed good durability, and main performance indicators did not significantly decline, meeting the reliability requirements for professional high-frequency use.

### Experimental Example 5

### Different Load and Environmental Adaptability Tests

Test object: Accessory of Embodiment 2 (2 floating claw, and 3 fixed claws, suitable for heavier lenses).

Test conditions: A telephoto lens weighing about 2 kg was tested in the following environment:

High temperature and high humidity: The accessory was kept standing at the temperature of 50 °C and 90% humidity for 8 hours and then subject to the connection stability test (same as Experimental Example 1).

Low temperature: The accessory was kept standing at the temperature of −20 °C for 8 hours and then subject to the connection stability test.

TABLE 5
(Test Results of Experimental Example 5)

| | Amount of connection | Number of signal | Smoothness of |
|---|---|---|---|
| Ambient | shaking (under running | interruptions (under | disassembly |
| conditions | vibration) | vibration) | operation |
| High temperature | ≤0.10 mm | 0 | Normal, no significant |
| and high humidity | | | change in unlocking force |
| Low temperature | ≤0.09 mm | 0 | Slightly stiff, the |
| | | | unlocking force |
| | | | increased by 15%, |
| | | | but disassembly |
| | | | could still be |
| | | | operated with one hand |

Conclusion: The present invention could maintain good connection stability and signal reliability at different ambient temperatures and loads, and had strong adaptability. The operation was felt slightly different at low temperatures, but the function was not affected.

### III. COMPARATIVE EXAMPLES

### Comparative Example 1

### Traditional Fixed Claw Structure

Structure description: Both the male snap ring and the female snap ring have fixed claws (without floating claw), and lack elastic anti-backlash structure. The number and layout of claws are the same as those in Embodiment 1, but all claws are rigidly connected. Signal terminals are conventional spring-loaded pin type, without special co-location design. Disassembly requires direct rotation and removal with force.

### Performance:

Poor connection stability: As shown in Experimental Example 1, there is a significant initial clearance and significant shaking under vibration.

The signal is easily interrupted: As shown in Experimental Example 2, the terminal contact is unreliable under vibration, and the signal transmission is unstable.

Disassembly is inconvenient and dangerous: Disassembly lacks guidance, making it easy to apply incorrect force, and long-term use is likely to cause terminal scratches and damage.

No clearance compensation: After long-term use, wear causes further increase of clearance and accelerates performance decline.

### Comparative Example 2

Fixed Claw Structure with Simple Elastic Piece Only

Structure description: Based on the traditional fixed claw structure (such as Comparative Example 1), only small elastic pieces are added to the back of 1-2 claws of the female snap ring in an attempt to provide a weak axial pretightening force. No floating claw, no release button, the positioning pin is a pure mechanical buckle.

### Performance:

Limited compensation effect: The simple elastic pieces can only provide local and limited axial pressure, cannot achieve uniform circumferential load distribution, cannot eliminate the radial clearance, and cannot improve the shaking problem significantly.

Poor coordination: Mechanical locking, signal mating, and clearance compensation are independent and do not form a linkage. Assembly causes different feelings, and mating accuracy of signal terminals still depends on processing accuracy.

Problem remains: The improvement of signal stability under vibration is limited, and the disassembly operation is the same as the traditional method, so there are still risks.

### Comparative Example 3

### Snap-on Locking Structure (Common Consumer Products)

Structure description: A button buckle is used for axial locking (non-rotational locking), there is no floating claw, and usually simple elastic contacts are used for signal transmission. To disassemble, the snap button is pressed for direct pull-out.

### Performance:

Weak load-bearing capacity: The snap-fit structure has the risk of accidental disengagement when subjected to large axial forces (such as the gravity of a telephoto lens) or lateral impacts, resulting in insufficient safety.

Poor connection rigidity: Pure axial locking lacks the high rigidity brought by circumferential rotational locking, and has weak torsion resistance.

Signal terminals are vulnerable: Direct insertion and removal require extremely high alignment and wear resistance of signal terminals, and frequent insertion and removal result in a high rate of terminal damage.

### IV. CONCLUSIONS

Comparison with the above experimental examples and comparative examples fully proves the superiority of the technical solution described in the present invention:

Fundamentally solving the shaking problem: The collaborative design of the “floating claw” and the “elastic anti-backlash structure” allows to actively and adaptively eliminate the fit clearance in both radial and axial dimensions, significantly outperforming the passive or partial compensation solution of Comparative Examples 1 and 2.

Achieving integrated and reliable connection: Multiple functions such as mechanical locking, precise positioning, signal mating, and clearance elimination are linked together in a single rotational assembly action, forming an organic whole, and ensuring high reliability at the system level (Experimental Examples 2 and 4).

Improving user experience and safety: The optimized disassembly mechanism (release button+positioning pin) makes the operation faster and safer on the premise of ensuring a firm connection, and avoids damage to precision signal terminals (Experimental Example 3).

The accessory of the present invention has excellent comprehensive durability and environmental adaptability (Experimental Examples 4 and 5), and meets the demanding requirements of professional and industrial application scenarios.

Being suitable for professional devices: The stability and reliability of the accessory of the present invention readily meet the requirements of professional photography, film and television industries, and other fields.

The above are only preferred embodiments, experimental examples, and comparative examples of the present invention, and are not intended to limit the protection scope of the present invention. Any modifications, equivalent substitutions, and improvements made by any person skilled in the art within the spirit and principles of the present invention should be included in the protection scope of the present invention.

What is claimed is:

1. An accessory of an interchangeable lens mount, comprising a lens and a camera device, the lens comprising a male snap ring (1), a lens signal terminal group (2), a positioning pin (3), and a limiting post (4), the camera device comprising a female snap ring (5), a camera device signal terminal group (6), a positioning pin snap-in hole (7), a slider (8), a release button (9), and an elastic anti-backlash structure (10), wherein at least one floating claw (11) and several fixed claws (12) are provided on the male snap ring (1), several claws (13) are provided on the female snap ring (5), and the number of claws (13) of the female snap ring (5) is equal to a sum of the number of the fixed claws (12) and the number of the floating claw (11);
the floating claw (11) and the fixed claws (12) of the male snap ring (1) and the claws (13) of the female snap ring (5) are snap-fitted to each other to achieve axial limit of the camera device and the lens;
the floating claw (11) is fixed to a side wall of the male snap ring (1) and located between two fixed claws (12), the floating claw (11) is telescopically movable in a direction perpendicular to an axis of the male snap ring (1), and the floating claw (11) is capable of adaptively eliminating a radial clearance between the lens and the camera device and enhances axial mounting firmness; and
the lens signal terminal group (2) is mounted and attached to an inner wall of the male snap ring (1), after the lens is mounted and fixed, the lens signal terminal group (2) and the camera device signal terminal group (6) are communicated in one-to-one correspondence to achieve interactive transmission of control instructions and signal protocols between the lens and the camera device.

2. The accessory of an interchangeable lens mount according to claim 1, wherein the floating claw (11) is connected with the male snap ring (1) via an elastic carrier, the elastic carrier is a compression spring (14), one end of the compression spring (14) is fixedly connected with the bottom of a mounting groove of the male snap ring (1), the other end is fixedly connected with the bottom of the floating claw (11), and the floating claw (11) achieves telescopic movement in the direction perpendicular to the axis of the male snap ring (1) by extension and retraction of the compression spring (14).

3. The accessory of an interchangeable lens mount according to claim 2, wherein a width angle of the floating claw (11) is smaller than width angles of two adjacent fixed claws (12); a connecting line between one end of the floating claw (11) and an axis center of the male snap ring (1) and a connecting line between an adjacent end of the adjacent fixed claw (12) and the axis center of the male snap ring (1) form θ3 and θ4, with θ3+θ4<160 degrees, θ3<160 degrees, and θ4<160 degrees.

4. The accessory of an interchangeable lens mount according to claim 3, wherein a connecting line between a midpoint of an edge of the positioning pin (3) and the axis center of the male snap ring (1) cuts θ3 or θ4 into θ1 and θ2, with θ1+θ2<90 degrees.

5. The accessory of an interchangeable lens mount according to claim 3, wherein the width angle of the fixed claw (12) is a fan-shaped angle formed by a connecting line between a vertex of one end of the fixed claw (12) and the axis center of the male snap ring (1) and a connecting line between a vertex of the other end of the fixed claw (12) and the axis center of the male snap ring (1), and the width angle of the fixed claw (12) ranges from 30 degrees to 60 degrees.

6. The accessory of an interchangeable lens mount according to claim 1, wherein the elastic anti-backlash structure (10) comprises five elastic pieces (15), the five elastic pieces (15) are arranged in one-to-one correspondence with the claws (13) of the female snap ring (5), one end of the elastic piece (15) is fixedly connected with the female snap ring (5), and the other end extends toward the claws of the male snap ring (1), and after the male snap ring (1) and the female snap ring (5) are snap-fitted, the elastic pieces (15) abut against the corresponding claws (13) and undergo elastic deformation.

7. The accessory of an interchangeable lens mount according to claim 1, wherein a wedge-shaped fitting structure (16) is provided between the release button (9) and the slider (8), the release button (9) is capable of performing linear movement in a direction parallel to the axis of the male snap ring (1), the linear movement is converted into a vertical displacement of the slider (8) by the wedge-shaped fitting structure (16), and the slider (8) is used to eject the positioning pin (3) and separate the positioning pin from the positioning pin snap-in hole (7).

8. The accessory of an interchangeable lens mount according to claim 1, wherein an elastic reset member is provided between the positioning pin (3) and the male snap ring (1), the elastic reset member is a reset elastic piece (17), and the reset elastic piece (17) is sleeved on an outside of the positioning pin (3) and is used to drive the positioning pin (3) into the positioning pin snap-in hole (7).

9. The accessory of an interchangeable lens mount according to claim 1, wherein the lens signal terminal group (2) and the camera device signal terminal group (6) are both elastic terminals, contact end faces thereof are provided with wear-resistant coatings, and the wear-resistant coating is a gold plating layer.

10. The accessory of an interchangeable lens mount according to claim 1, wherein an outer side wall of the male snap ring (1) is provided with an assembly mark, and an outer side wall of the female snap ring (5) is correspondingly provided with an alignment mark; when the lens is assembled, the assembly mark is aligned with the alignment mark; and when the lens is disassembled, the lens is rotated until the assembly mark and the alignment mark are aligned again, and then the lens is pulled out along the axis.
